(19) United States
(12) Patent Application Publication
(10) Pub. No.: US 2008/0204397 A1
(43) Pub. Date: Aug. 28, 2008

(54) BACKLIGHT DEVICE AND LIQUID CRYSTAL DISPLAY DEVICE HAVING THE SAME

(76) Inventors: Hyeon-Yong JANG, Osan-si (KR); Seong-Sik CHOI, Seoul (KR)

Correspondence Address: F. CHAU & ASSOCIATES, LLC, 130 WOODBURY ROAD, WOODBURY, NY, 11797, US

(21) Appl. No.: 12/020,146

(22) Filed: Jan. 25, 2008

(30) Foreign Application Priority Data
Feb. 22, 2007 (KR) 2007-17658

(51) Int. Cl. G02F 1/13357; G09G 3/36

(52) U.S. Cl. 345/102; 349/69

(57) ABSTRACT

A backlight device for a liquid crystal display (LCD) panel displaying an image is disclosed. The backlight device includes a plurality of light source groups and a light source driving section. The light source groups include a predetermined number of light sources providing the LCD panel with light. The light source driving section sequentially and repeatedly provides power to the light source groups during a unit frame interval.

### CROSS-REFERENCE TO RELATED APPLICATIONS

This application claims priority under 35 U.S.C. §119 to Korean Patent Application No. 2007-17658, filed on Feb. 22, 2007, in the Korean Intellectual Property Office (KIPO), the disclosure of which is herein incorporated by reference in its entirety.

### BACKGROUND OF THE INVENTION

1. Technical Field

The present disclosure relates to a backlight device and a liquid crystal display (LCD) device having the backlight device.

2. Discussion of Related Art

A display device can display images by converting electronically formatted data into a visible image, which is processed in an information-processing device of an electronic device. Display devices may include cathode ray tube (CRT) devices, plasma display panel (PDP) devices, liquid crystal display (LCD) devices, organic electroluminescent display (OELD) devices, etc. The LCD device displays an image using liquid crystal molecules. Electrical and optical characteristics of the liquid crystal molecules vary in response to an applied electric field. The LCD device is widely used in various display devices, because it is relatively light in weight, thin, and consumes a small amount of power as compared with other types of display devices.

The LCD device is a non-emissive type display device, requiring a light source, such as a backlight device, to supply light to an LCD panel of the LCD device.

An LCD device may employ a light source that emits a white light, such as a cold cathode fluorescent lamp (CCFL), a flat fluorescent lamp (FFL), etc.

An LCD device that employs a light source which includes a red light-emitting diode (LED), a green LED and a blue LED has been developed to enhance color reproducibility.

The LCD device displays an image using a liquid crystal material that has optical characteristics, such as anisotropy of refractivity, as well as electrical characteristics, such as anisotropy of dielectric constant. However, when the LCD device displays a dark image, the LCD device may leak light and contrast characteristics of the LCD device may deteriorate.

When a moving image is displayed on the LCD device, as a supply voltage level is held constant for each frame, an afterimage remains, which decreases the display quality.

Dimming of a backlight or local dimming can be performed to reduce the amount of light leaked during the display of a dark image.

Double-speed frame or sequential driving can be performed to reduce after-images. In sequential driving, a lighting level of the backlight is adjusted based on an image display time. While the local dimming and sequential driving may be realized using an LED, this also increases manufacturing costs.

A backlight apparatus has been developed which includes a charging capacitor connected in parallel with an LED that reduces manufacturing costs.

Energy is charged in the LED and the charging capacitor during an initial interval of a unit frame. A driving current generated in accordance with a discharging of the charging capacitor is provided to the LED during the remaining interval of the unit frame.

During the initial interval of the unit frame, a pulse width of a scan signal may be in the order of a few milliseconds (ms) to activate a scan line electrically connected to the LED. Accordingly, the capacitor requires a large capacitance of a few hundred microfarads (μF).

Thus, there is a need for a backlight device for an LCD having a capacitor connected in parallel with an LED which can operate with a reduced capacitance.

### SUMMARY OF THE INVENTION

In an exemplary embodiment of the present invention, a backlight device for an LCD panel displaying an image is provided. The backlight device includes a plurality of light source groups and a light source driving section. The light source groups include a predetermined number of light sources providing the LCD panel with light. The light source driving section sequentially and repeatedly provides the light source groups with power during a unit frame interval.

The light source groups may be disposed in rows.

Each of the light sources may include an LED. Each of the light source groups may further include a capacitor electrically connected to an LED. A capacitance of the capacitor may be between about 0.1 microfarads (μF) to 1 about μF.

The light source driving section may include a sample-and-hold (S/H) part and a power generating part. The S/H part samples and holds image data of the image, and outputs the sampled and held image data based on a first selection signal. The power generating part provides the light sources with power corresponding to the sampled and held image data based on a second selection signal. The second selection signal may include an output enable signal that is activated for each frame of the image. The first selection signal may be synchronized with the second selection signal.

The backlight device may further include a plurality of scan lines transmitting a scan signal to the light sources, and a plurality of power lines crossing the scan lines, the power lines transmitting the electrical energy to the light sources. The scan signal may be a pulse that repeatedly transitions from a high level to a low level during a unit frame interval.

The light source section may include a power driving part and a scan signal outputting part. The power driving part provides the power lines with the power. The scan signal outputting part outputs the scan signal to the scan lines to provide the light sources with the power at a plurality of different times, during a unit frame interval.

Each of the light sources may include a first end terminal electrically connected to a power line and a second end terminal electrically connected to a scan line. The backlight device may further include a capacitor including a first end terminal commonly connected to a light source to be electrically connected to a power line, and a second end terminal electrically connected to the scan line. The backlight device may further include a resistor disposed between a scan line and a light source to protect against an overcurrent. A capacitance of the capacitor may be between about 0.1 μF to about 1 μF.

In exemplary embodiment of the present invention, an LCD device may include an LCD panel and a backlight section. The LCD panel displays an image using liquid crystal molecules interposed between two substrates. The backlight section may include a plurality of light source groups and a light source driving section. The light source groups include a predetermined number of light sources providing the LCD panel with light. The light source driving section sequentially and repeatedly provides the light source groups with power during a unit frame interval.

The backlight section may include a plurality of scan lines, a plurality of power lines and a capacitor. The scan lines are electrically connected to the light sources. The scan lines transmit a scan signal to the light sources. The power lines are electrically connected to the light sources. The power lines transmit the power to the light sources. The capacitor includes a first end terminal commonly connected to a light source to be electrically connected to a power line, and a second end terminal electrically connected to the scan line.

The backlight section may further include a resistor disposed between a scan line and a light source to protect against an overcurrent. A capacitance of the capacitor may be between about 0.1 μF to about 1 μF.

The backlight section may include a power driving part and a scan signal outputting part. The power driving part provides the power lines with the power. The scan signal outputting part outputs the scan signal to the scan lines to provide the light sources with the power at a plurality of different times, during a unit frame interval. A first scan signal provided to a first one of the scan lines may be a pulse that repeatedly transitions from a high level to a low level during a unit frame interval, and a second scan signal provided to a second line adjacent to the first scan line may be a pulse that repeatedly transitions from a high level to a low level during a unit frame interval. The second scan line may have a low level when the first scan line has a high level.

### BRIEF DESCRIPTION OF THE DRAWINGS

The present invention will become more apparent by describing in detail exemplary embodiments thereof with reference to the accompanying drawings in which:

FIG. 1 is a block diagram illustrating a backlight device according to an exemplary embodiment of the present invention;

FIG. 2 is a block diagram illustrating an embodiment of the light source section and the power driving section of FIG. 1;

FIG. 3 is a block diagram illustrating an embodiment of a scan signal outputting section of FIG. 1;

FIG. 4 is a waveform diagram illustrating scan signals that are output from the scan signal outputting section of FIG. 3;

FIG. 5A is a waveform diagram illustrating a light-emitting diode (LED) voltage that is charged and held in accordance with a scan signal according to an exemplary embodiment of the present invention;

FIG. 5B is a waveform diagram illustrating an LED voltage that is charged and held in accordance with a scan signal according to an exemplary embodiment of the present invention; and

FIG. 6 is a block diagram illustrating a liquid crystal display (LCD) device according to an exemplary embodiment of the present invention.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein.

It will be understood that when an element or layer is referred to as being “on,” “connected to” or “coupled to” another element or layer, it can be directly on, connected or coupled to the other element or layer or intervening elements or layers may be present. Like numbers may refer to like elements throughout. Hereinafter, the present invention will be described in detail by explaining exemplary embodiments of the invention with reference to the accompanying drawings.

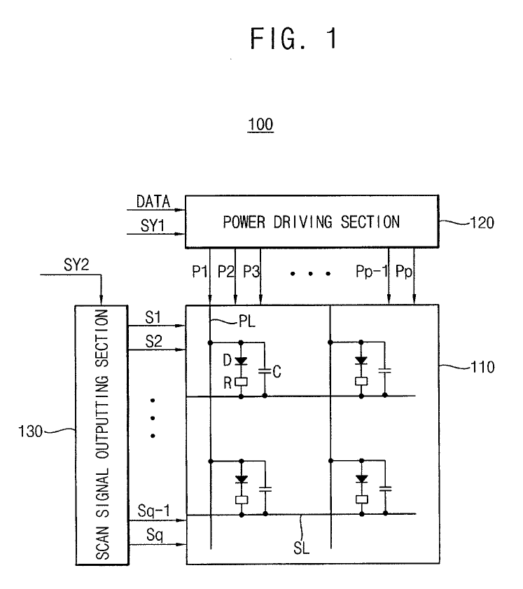

FIG. 1 is a block diagram illustrating a backlight device according to an exemplary embodiment of the present invention.

Referring to FIG. 1, a backlight device 100 according to an exemplary embodiment of the present invention includes a light source section 110, a power driving section 120 and a scan signal outputting section 130. The backlight device 100 is disposed behind a liquid crystal display (LCD) panel (not shown) displaying images to provide the LCD panel with light.

The light source section 110 includes a plurality of light source groups that are disposed on a plane. Each of the light source groups includes a predetermined number of light sources to provide the LCD panel with light. The light source groups are grouped into rows. Each of the light sources may include a light-emitting diode (LED) D.

Each of the light source groups may include a resistor R serially connected to an LED D and a capacitor C connected in parallel with the LED D. The resistor R may prevent against an overcurrent flowing into the LED D when the capacitor C is charged or discharged.

The light source section 110 may further includes a plurality of power lines PLs and a plurality of scan lines SLs.

The power lines PLs are arranged in a vertical direction when viewed in a plan view. Each of the power lines PLs are electrically connected to an anode of an LED D and a first terminal of a corresponding capacitor C. Each of the power lines PLs delivers one of powers P1, P2, . . . , Pp-1 and Pp provided from the power driving section 120 to the LED D and the corresponding capacitor C.

The scan lines SLs cross the power lines PLs. The scan lines SLs are disposed in a horizontal direction and are electrically connected to a first end of a resistor R electrically connected to a cathode of an LED D and a second end of a corresponding capacitor C. The scan lines SLs deliver the scan signals S1, S2, . . . , Sq-1 and Sq provided from the scan signal outputting section 130 to each resistor R and corresponding capacitor C.

The power driving section 120 and the scan signal outputting section 130 provide power to the light source section 110. For example, the power driving section 120 sequentially and repeatedly provides powers P1, P2, . . . , Pp-1 and Pp to each of the light source groups through the power lines PLs.

The scan signal outputting section 130 outputs the scan signals S1, S2, . . . , Sq-1 and Sq to the scan lines SLs sequentially and repeatedly to provide power to the light source groups during a unit frame interval. The unit frame interval may be, for example, one frame interval.

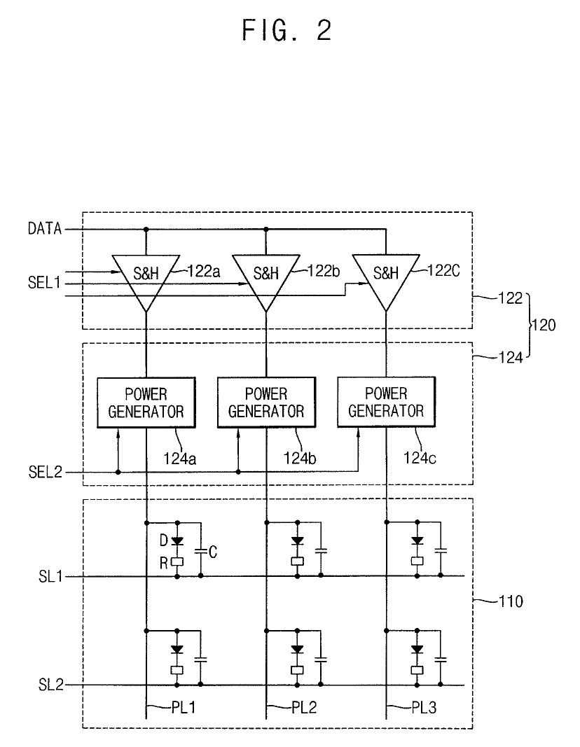

Light source groups are arranged in a predetermined number of rows and the rows are sequentially and repeatedly triggered to emit light FIG. 2 is a block diagram illustrating an embodiment of the light source section 110 and the power driving section 120 of FIG. 1. In FIG. 2, the power driving section 120 is illustrated with three power lines for ease of discussion. However, the power driving section 120 is not limited thereto, as it may include any suitable number of power lines.

Referring to FIGS. 1 and 2, the power driving section 120 includes a sample-and-hold (S/H) part 122 and a power generating part 124. The power driving section 120 provides power to first, second and third power lines PL1, PL2 and PL3 disposed in the light source section 110.

The S/H part 122 includes a first sample-and-holder 122a, a second sample-and-holder 122b and a third sample-and-holder 122c. Each of the first, second and third sample-and-holders 122a, 122b and 122c samples and holds image data DATA of an image, and outputs the sampled and held image data to the power generating part 124 in response to a first selection signal SEL1 provided from an external source.

The power generating part 124 includes a first power generator 124a, a second power generator 124b and a third power generator 124c. Each of the first, second and third power generators 124a, 124b and 124c provides the light source section 110 with powers corresponding to the sampled and held image data.

Each of the first, second and third power generators 124a, 124b and 124c intercepts the powers provided to the light source section 110 in response to a second selection signal SEL2 provided from an external source. The second selection signal SEL2 includes, for example, a data enable signal (DE) activated for each frame of the image. The first selection signal SEL1 is synchronized with the second selection signal SEL2.

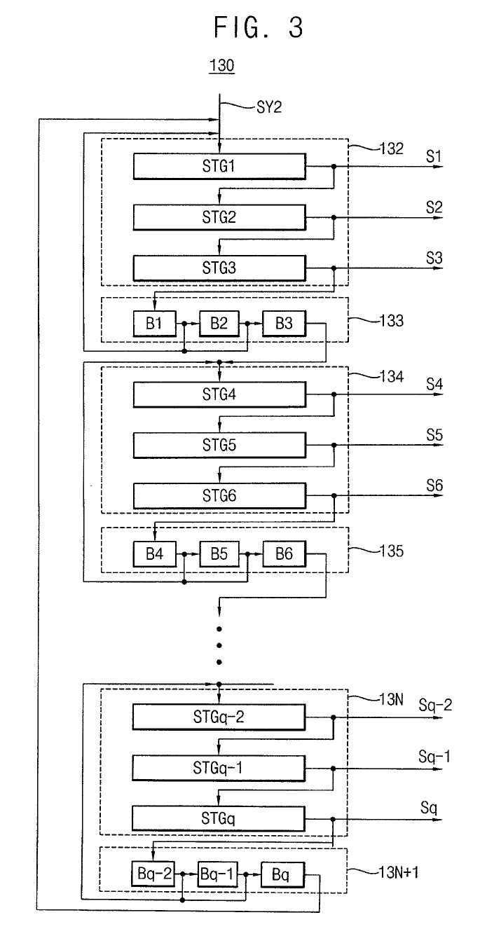

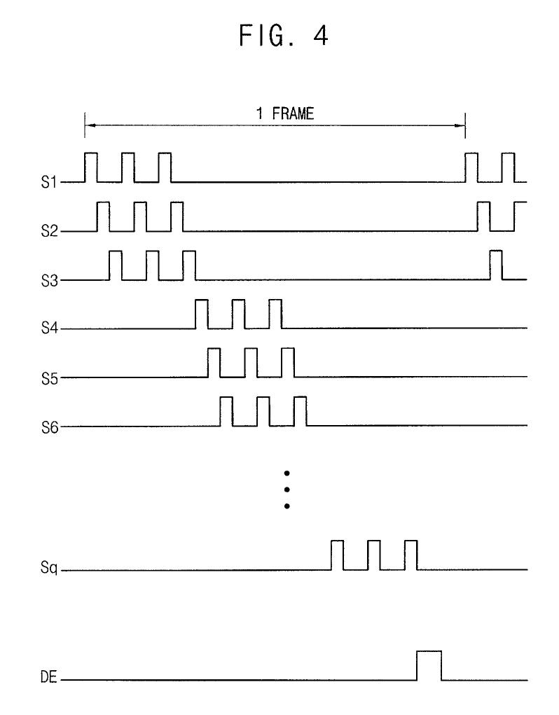

FIG. 3 is a block diagram illustrating an embodiment of the scan signal outputting section shown in FIG. 1. FIG. 4 is a waveform diagram illustrating scan signals that are output from the scan signal outputting section of FIG. 3.

Referring to FIGS. 1 to 4, the scan signal outputting section 130 includes a plurality of group stages 132, 134, . . . , 13N, and a plurality of group buffers 133, 135, . . . , 13N+1 disposed between the group stages 132, 134, . . . , 13N.

The first group stage 132 includes a first stage STG1, a second stage STG2 and a third stage STG3. The first, second and third stages STG1, STG2 and STG3 are cascade-connected with each other. The first, second and third stages STG1, STG2 and STG3 sequentially and repeatedly provide a first scan line SL1, a second scan line SL2 and a third scan line SL3 with a first scan signal S1, a second scan signal S2 and a third scan signal S3, respectively, in response to a second synchronizing signal SY2.

The first group buffer 133 includes a first buffer B1, a second buffer B2 and a third buffer B3. The first group buffer 133 controls the first, second and third scan signals S1, S2 and S3 to provide the first, second and third scan lines SL1, SL2 and SL3 with the first, second and third scan signals S1, S2 and S3.

For example, the first buffer B1 receives the third scan signal S3 from the third stage STG3, and buffers the third scan signal S3. Then, the first buffer B1 activates the first stage STG1, and provides the second buffer B2 with the first buffered signal.

The second buffer B2 receives the first buffered signal from the first buffer B1, and buffers the first buffered signal. Then, the second buffer B2 activates the first stage STG1, and provides the third buffer B3 with the second buffered signal.

The third buffer B3 receives the second buffered signal from the second buffer B2, and buffers the second buffered signal. Then, the third buffer B3 provides the fourth stage STG4 with a signal for activating the fourth stage STG4.

The second group stage 134 includes a fourth stage STG4, a fifth stage STG5 and a sixth stage STG6. The fourth, fifth and sixth stages STG4, STG5 and STG6 are cascade-connected with each other. The fourth, fifth and sixth stages STG4, STG5 and STG6 sequentially and repeatedly provide a fourth scan line SL4, a fifth scan line SL5 and a sixth scan line SL6 with a fourth scan signal S4, a fifth scan signal S5 and a sixth scan signal S6, respectively, in response to the third buffered signal provided from the third buffer B3 of the first group buffer 133.

The second group buffer 135 includes a fourth buffer B4, a fifth buffer B5 and a sixth buffer B6. The second group buffer 135 controls the fourth, fifth and sixth scan signals S4, S5 and S6 to provide the fourth, fifth and sixth scan lines SL4, SL5 and SL6 with the fourth, fifth and sixth scan signals S4, S5 and S6, respectively.

For example, the fourth buffer B4 receives the third buffered signal from the third buffer B3, and buffers the third buffered signal. Then, the fourth buffer B4 activates the fourth stage STG4, and provides the fifth buffer B5 with the fourth buffered signal.

The fifth buffer B5 receives the fourth buffered signal from the fourth buffer B4, and buffers the fourth buffered signal. Then, the fifth buffer B5 activates the fifth stage STG5, and provides the sixth buffer B6 with the fifth buffered signal.

The sixth buffer B6 receives the fifth buffered signal from the fifth buffer B5, and buffers the fifth buffered signal. Then, the sixth buffer B6 provides the seventh stage STG7 with a signal for activating the seventh stage STG7.

Through the above-mentioned method, a plurality of group stages and a plurality of group buffers activate the scan lines to sequentially and repeatedly provide power to the light source groups.

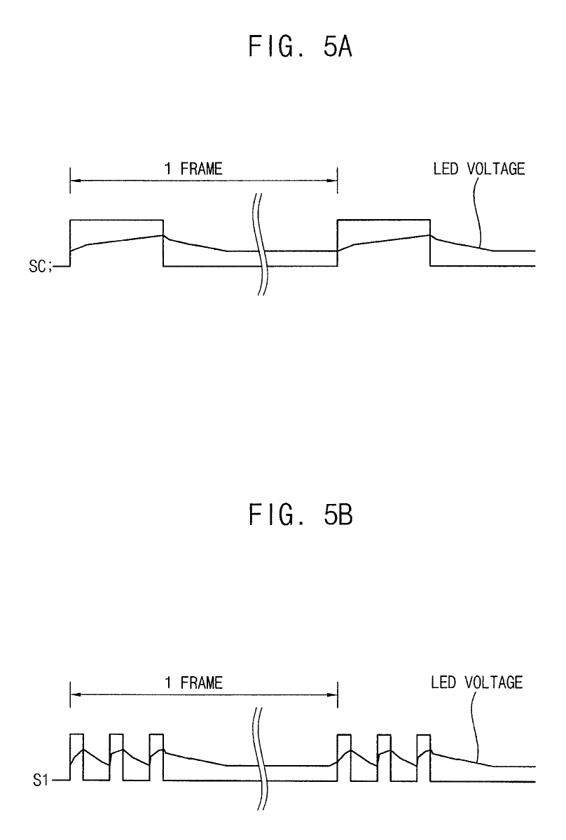

FIG. 5A is a waveform diagram illustrating an LED voltage that is charged and held in accordance with a scan signal according to an exemplary embodiment of the present invention. FIG. 5B is a waveform diagram illustrating an LED voltage that is charged and held in accordance with the scan signal applied to the scan signal outputting section shown in FIG. 3.

Referring to FIG. 5A, a general scan signal Sc maintains a high level during an initial interval of a unit frame, and maintains a low level during the remaining interval of the unit frame.

The capacitors C (as shown in FIG. 1 and 2) of each of the light source groups are charged in response to the scan signal Sc of a high level, and apply currents to the LEDs D by holding the charges in response to the scan signal Sc of a low level.

However, a pulse width of the scan signal may be a few milliseconds (ms), requiring the capacitors C to have a capacitance on the order of a few hundred microfarads (μF).

Referring to FIG. 5B, the scan signal S1 of FIG. 5B repeatedly transitions from a high level to a low level during an initial interval, and maintains a low level during the remaining interval. The length of the interval is substantially the same as the length the scan signal Sc at the high level shown in FIG. 5A.

The capacitors C of each of the light source groups are charged and hold an electric charge in response to the scan signal Sc repeatedly transitioning from the high level to low level. The capacitors apply currents to the LEDs D by holding the charges in response to the scan signal Sc of a low level.

A pulse width of the scan signal S1 of FIG. 5B is relatively thinner than the scan signal Sc shown in FIG. 5A. The scan signal S1 repeatedly transitions from a high level to a low level and is applied to the LED, so that energy is dispersed evenly. Therefore, even though a capacitance of the capacitor C corresponding to the scan signal of FIG. 5B may be smaller than that of the capacitor C corresponding to the scan signal shown in FIG. 5A, the capacitor corresponding to the scan signal of FIG. 5B may be sufficient to operate the backlight device. For example, a capacitance of the capacitor C corresponding to the scan signal of FIG. 5B may be between about 0.1 μF to about 1 μF.

In addition, light may be sequentially emitted from adjacent light source groups so that the backlight device may be driven similarly to the sequential driving mode.

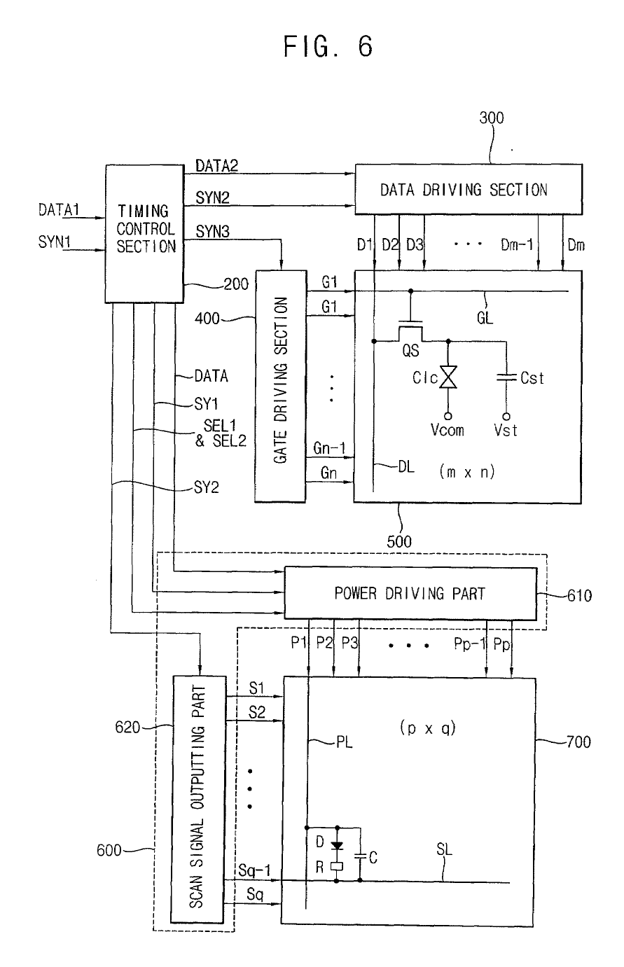

FIG. 6 is a block diagram illustrating an LCD device according to an exemplary embodiment of the present invention.

Referring to FIG. 6, an LCD device according to an exemplary embodiment of the present invention includes a timing control section 200, a data driving section 300, a gate driving section 400, an LCD panel 500, a light source control section 600 and a light source section 700. The timing control section 200, the data driving section 300 and the gate driving section 400 define an image signal processing section that provides the LCD panel 500 with image data provided from an external device such as a graphic controller. The light source control section 600 and a light source section 700 define a backlight device that provides light to the LCD panel 500 that displays an image using liquid crystal molecules.

The timing control section 200 receives first image data DATA1 and a first synchronization signal SYN1 from an external source such as a graphic controller, and outputs second image data DATA2 and a second synchronization signal SYN2 to the data driving section 300. The timing control section 200 outputs a third synchronization signal SYN3 and the second image data DATA2 to the gate driving section 400 and the light source control section 600, respectively. The first synchronizing signal SYN1 may include a vertical synchronizing signal (Vsync), a horizontal synchronizing signal (Hsync), a main clock signal (MCLK), and a data enable signal (DE). The vertical synchronizing signal (Vsync) represents a time required for displaying one frame. The horizontal synchronizing signal (Hsync) represents a time required for displaying one line of the frame. The horizontal synchronizing signal includes pulses corresponding to the number of pixels included in one line. The data enable signal (DE) represents a time required for supplying a pixel with data. The second synchronizing signal SYN2 may include a load signal LOAD, a horizontal start signal STH and a polarity control signal REV for outputting the second data signal DATA2. The polarity control signal REV may control a polarity of the second image data DATA2. The third synchronizing signal SYN3 may include a gate clock signal (CPV or GCLK) and a vertical start signal (STV).

The data driving section 300 outputs a data signal to the LCD panel 500 with respect to the second image data DATA2 and the second synchronization signal SYN2. While the timing control section 200 and the data driving section 300 have been separately described, they may be included together in a same physical hardware element.

The gate driving section 400 outputs a gate signal to the LCD panel 500 with respect to the third synchronization signal SYN3.

The LCD panel 500 displays images using liquid crystal molecules that are disposed between two substrates.

The LCD panel 500 includes a plurality of data lines DL, a plurality of gate lines GL and a switching element QS that is formed in an area defined by the data lines and the gate lines, respectively.

The data lines DLs extend along a first direction. The data lines DLs transfer a plurality of data signals D1, D2, D3, . . . , Dm-1,Dm to the switching element QS. The gate lines GLs extend along a second direction that is substantially perpendicular to the first direction. The gate lines GLs sequentially transfer a plurality of gate signals G1, G2, . . . , Gn-1, Gn to the switching element QS. The gate signals G1, G2, . . . , Gn-1, Gn have a voltage level for turning on/off the switching element QS.

The switching element QS includes a source electrode, a gate electrode and a drain electrode. The source electrode is electrically connected to the data line DL, so that the source electrode receives the data signal. The gate electrode is electrically connected to the gate line GL, so that the gate electrode receives the gate signal. The drain electrode is electrically connected to a liquid crystal capacitor Clc and a storage capacitor Cst.

The light source driving section 600 includes a power driving part 610 and a scan signal outputting part 620. The power driving part 610 may be configured as a stand-alone unit, separate from the timing control section 200. Alternately, the power driving part 610 and the timing control section 200 may be configured as a single chip. The power driving part 610 and the scan signal outputting part 620 may be substantially the same as the power driving section 120 and the scan signal outputting section 130, respectively, as shown in FIG. 1.

In addition, the light source section 700 may be substantially the same as the light source section 110 shown in FIG. 1.

A backlight device according to an exemplary embodiment of the present invention includes a capacitor that is connected in parallel with an LED and has a capacitance of about 0.1 μF to about 1 μF, which is less than conventional backlights that may require a capacitance on the order of a few hundred μF.

A scan signal may be provided sequentially to each LED to repeatedly transition from a high level to a low level during a unit frame interval.

Therefore, during one frame interval, power may be sequentially and repeatedly provided to light source groups including a plurality of LEDs disposed along a same row, and then the power may be sequentially and repeatedly provided to a next row of light source groups, so that a capacitance of each of the capacitors connected in parallel with the LEDs, respectively, may be reduced.

Having described exemplary embodiments of the present invention, it is to be understood that the present invention is not limited to these exemplary embodiments and various changes and modifications can be made by one ordinary skilled in the art within the spirit and scope of the present invention.

What is claimed is:

1. A backlight device for a liquid crystal display (LCD) panel, the backlight device comprising:
a plurality of light source groups having a predetermined number of light sources providing the LCD panel with light; and
a light source driving section sequentially and repeatedly providing power to the light source groups during a unit frame interval.

2. The backlight device of claim 1, wherein the light source groups are disposed in rows.

3. The backlight device of claim 1, wherein each of the light sources comprises a light-emitting diode (LED).

4. The backlight device of claim 3, wherein the light source groups further comprise a capacitor electrically connected to the LED.

5. The backlight device of claim 4, wherein a capacitance of the capacitor is about 0.1 microfarads (μF) to about 1 μF.

6. The backlight device of claim 1, wherein the light source driving section comprises:
a sample-and-hold (S/H) part sampling and holding image data of an image, and outputting the sampled and held image data based on a first selection signal; and
a power generating part providing the light sources with power corresponding to the sampled and held image data based on a second selection signal.

7. The backlight device of claim 6, wherein the second selection signal includes an output enable signal that is activated between each frame of the image.

8. The backlight device of claim 7, wherein the first selection signal is synchronized with the second selection signal.

9. The backlight device of claim 1, further comprising:
a plurality of scan lines transmitting a scan signal to the light sources; and
a plurality of power lines crossing the scan lines, the power lines transmitting the power to the light sources.

10. The backlight device of claim 9, wherein the scan signal is a pulse that repeatedly transitions from a high level to a low level during a unit frame interval.

11. The backlight device of claim 9, wherein the light source section comprises:
a power driving part providing the power lines with the power; and
a scan signal outputting part outputting the scan signal to the scan lines to provide the light sources with the power at a plurality of different times, during a unit frame interval.

12. The backlight device of claim 9, wherein each of the light sources comprises a first end terminal electrically connected to one of the power lines power line and a second end terminal electrically connected to one of the scan lines, and
the backlight device further comprises a capacitor having a first end terminal commonly connected to one of the light sources to be electrically connected to the power line, and a second end terminal electrically connected to the scan line.

13. The backlight device of claim 12, further comprising a resistor disposed between the scan line and the light source to protect the light source against an overcurrent.

14. The backlight device of claim 12, wherein a capacitance of the capacitor is about 0.1 μF to about 1 μF.

15. A liquid crystal display (LCD) device comprising:
an LCD panel displaying an image; and
a backlight section comprising a plurality of light source groups comprising a predetermined number of light sources providing the LCD panel with light, and a light source driving section sequentially and repeatedly providing the light source groups with power during a unit frame interval.

16. The LCD device of claim 15, wherein the backlight section comprises:
a plurality of scan lines electrically connected to the light sources, the scan lines transmitting a scan signal to the light sources;
a plurality of power lines electrically connected to the light sources, the power lines transmitting the power to the light sources; and
a capacitor having a first end terminal commonly connected to at least one of the light source to be electrically connected to a power line, and a second end terminal electrically connected to the scan line.

17. The LCD device of claim 16, wherein the backlight section further comprises a resistor disposed between one of the scan lines and the light source to protect the light source against an overcurrent.

18. The LCD device of claim 17, wherein a capacitance of the capacitor is about 0.1 μF to about 1 μF.

19. The LCD device of claim 17, wherein the backlight section comprises:
a power driving part providing the power lines with the power; and
a scan signal outputting part outputting the scan signal to the scan lines to provide the light sources with the power at a plurality of different times, during a unit frame interval.

20. The LCD device of claim 19, wherein a first scan signal provided to a first one of the scan lines is a pulse that repeatedly transitions from a high level to a low level during a unit frame interval,
a second scan signal provided to a second line adjacent to the first scan line is a pulse that repeatedly transitions from a high level to a low level during a unit frame interval, and
the second scan signal has a low level, when the first scan signal has a high level.
